(19) United States
(12) Patent Application Publication
(10) Pub. No.: US 2026/0112678 A1
(43) Pub. Date: Apr. 23, 2026

(54) BATTERY CELL MANUFACTURING APPARATUS AND METHOD

(71) Applicant: SK ON CO., LTD., Seoul (KR)

(72) Inventors: Seung Won CHOI, Daejeon (KR); Jae Gyu BYUN, Daejeon (KR); Taek Eon JEONG, Daejeon (KR)

(21) Appl. No.: 19/295,709

(22) Filed: Aug. 11, 2025

(30) Foreign Application Priority Data
Oct. 18, 2024 (KR) 10-2024-0143112

(51) Int. Cl. H01M 10/04; H01M 50/105

(52) U.S. Cl. CPC H01M 10/0404; H01M 50/105

(57) ABSTRACT

An apparatus of manufacturing a battery cell including a case accommodating an electrode assembly and having a sealing portion formed on at least one edge thereof and a protrusion protruding laterally from the case includes a pressing jig pressing the sealing portion based on a virtual folding boundary line, a reference for folding the protrusion, to expose the protrusion laterally based on the folding boundary line and a folding roller folding the protrusion exposed by the pressing jig in a second direction, perpendicular to a first direction, while moving in the first direction along a side surface of the pressing jig and a side surface of the case.

### CROSS-REFERENCE TO RELATED APPLICATION(S)

This patent document claims the priority and benefits of Korean Patent Application No. 10-2024-0143112 filed on Oct. 18, 2024, the disclosure of which is incorporated herein by reference in its entirety.

### TECHNICAL FIELD

The disclosure relates to a battery cell manufacturing apparatus and a manufacturing method.

### BACKGROUND

Unlike primary batteries, secondary batteries have the convenience of being able to be charged with and discharged of electricity, and thus have come to prominence as a power source for various mobile devices and electric vehicles.

Secondary batteries may include battery cells in which an electrode assembly formed by stacking a positive electrode plate, a negative electrode plate, and a separator or formed by being wound in a roll shape is accommodated inside a case. A plurality of battery cells may be stacked in a predetermined direction and accommodated in a battery module or a battery pack.

Meanwhile, a plurality of battery cells may be accommodated in an internal space of a battery module or a battery pack. If an unnecessary portion exists in the case of the battery cell, energy density of the battery module or the battery pack may be reduced.

### SUMMARY

The present disclosure may be implemented in some embodiments to remove or minimize an unnecessary protrusion formed in a case of a battery cell.

The present disclosure may also be implemented in some embodiments to remove or minimize an unnecessary portion protruding from an edge of a case when an outer casing of the case is sealed.

The battery cell manufacturing apparatus and manufacturing method of the present disclosure may be widely applied to green technology fields, such as electric vehicles, battery charging stations, and solar power generation and wind power generation using batteries. In addition, the present disclosure may be used in eco-friendly electric vehicles, hybrid vehicles, etc. to prevent climate change by suppressing air pollution and greenhouse gas emissions.

In some embodiments of the present disclosure, an apparatus of manufacturing a battery cell including a case accommodating an electrode assembly and having a sealing portion formed on at least one edge thereof and a protrusion protruding laterally from the case includes: a pressing jig pressing the sealing portion based on a virtual folding boundary line that is a reference for folding the protrusion, to expose the protrusion laterally based on the folding boundary line; and a folding roller folding the protrusion exposed by the pressing jig in a second direction, perpendicular to a first direction, while moving in the first direction along a side surface of the pressing jig and a side surface of the case.

The folding boundary line may be a virtual line, parallel to the side surface of the case.

The folding roller may bend the protrusion based on the folding boundary line and press the protrusion against the side surface of the pressing jig.

The pressing jig may include a first pressing jig and a second pressing jig facing each other with the case interposed in between in the second direction, and the folding roller may press the protrusion against either a side surface of the first pressing jig or a side surface of the second pressing jig.

The side surface of the pressing jig may be disposed parallel to the side surface of the case in the first direction.

The protrusion may be pressed between the side surface of the pressing jig and the folding roller, in a state in which it is folded in the second direction based on the folding boundary line.

The folding roller may be provided to be inclined at a predetermined angle based on an axis, parallel to the second direction.

In some embodiments of the present disclosure, a method of manufacturing a battery cell including a case accommodating an electrode assembly and having a sealing portion formed on at least one edge thereof and a protrusion protruding laterally from the case includes: a first operation of preparing a battery cell with the protrusion protruding laterally from the case; a second operation of pressing the case with a pressing jig to expose the protrusion laterally; and a third operation of folding the protrusion exposed by the pressing jig in a second direction, perpendicular to a first direction, while the folding roller moves along the side surface of the pressing jig and the side surface of the case in the first direction.

The second operation may include an operation of setting a virtual line, parallel to the side surface of the battery cell, as a folding boundary line, and pressing the sealing portion by the pressing jig along the folding boundary line.

### BRIEF DESCRIPTION OF DRAWINGS

Certain aspects, features, and advantages of the present disclosure are illustrated by the following detailed description with reference to the accompanying drawings.

FIG. 1 is a view of a battery cell according to an embodiment of the present disclosure;

FIG. 2 is a diagram illustrating a process of manufacturing a battery cell using a pressing jig according to an embodiment of the present disclosure;

FIG. 3 is an enlarged view of portion A of FIG. 2;

FIG. 4 is a diagram illustrating an additional process of manufacturing a battery cell using a folding roller according to an embodiment of the present disclosure;

FIG. 5 is an enlarged view of portion B of FIG. 4;

FIGS. 6A and 6B are diagrams illustrating angles of a folding roller from the side of a battery cell;

FIG. 7 is a diagram illustrating that a protrusion is folded by a folding roller from the front of a battery cell;

FIG. 8 is a diagram illustrating that a protrusion is folded by a folding roller from the top of a battery cell;

FIG. 9 is a view of a battery cell with a folded protrusion according to an embodiment of the present disclosure; and

FIG. 10 is a flowchart of a method of manufacturing a battery cell according to an embodiment of the present disclosure.

### DETAILED DESCRIPTION

Hereinafter, an apparatus and method of manufacturing a battery cell according to an embodiment of the present disclosure will be described with reference to the accompanying drawings. First, a battery cell used in a manufacturing apparatus of the present disclosure will be described.

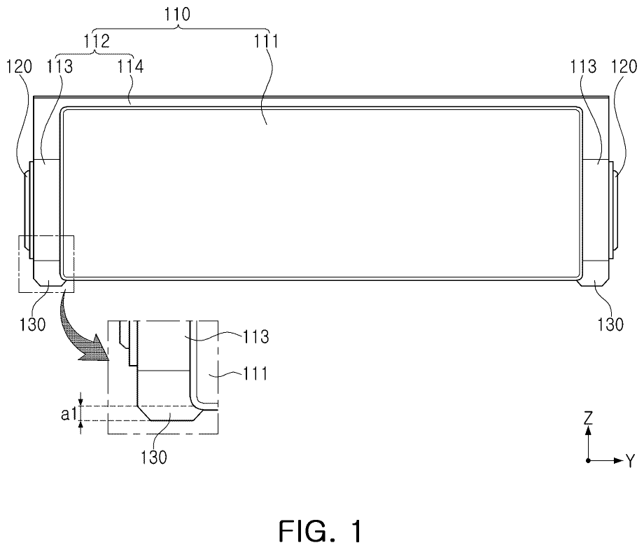

FIG. 1 is a view of a battery cell according to an embodiment of the present disclosure.

Referring to FIG. 1, a battery cell 100 according to an embodiment of the present disclosure may include a case 110 accommodating an electrode assembly (not illustrated) and a lead tab 120 electrically connected to the electrode assembly and protruding from at least one side of the case.

The electrode assembly may be configured in a form in which a positive electrode plate and a negative electrode plate are laminated with a separator interposed therebetween in a state in which wide surfaces thereof face each other. The positive electrode plate may be formed by applying a positive electrode active material to a positive electrode current collector, and the negative electrode plate may be formed by applying a negative electrode active material to a negative electrode current collector.

The separator may be configured to prevent an electrical short-circuit between the positive electrode plate and the negative electrode plate and to allow ion flow. For example, the separator may include a porous polymer film or a porous nonwoven fabric.

In addition, the electrode assembly may be accommodated in the case variously, such as a stacking type, a Z-folding type, a stack-folding type, as a jelly roll type by winding in a predetermined direction.

A plurality of battery cells 100 may be pouch-type, prismatic-type, or cylindrical-type secondary batteries depending on the structure of the case 110. In the present disclosure, the battery cell 100 is illustrated as a pouch cell in which the case 110 is formed of a pouch-type outer casing, but the present disclosure is not limited thereto. Meanwhile, in the present disclosure, descriptions are given based on a pouch-type pouch cell but the present disclosure is not necessarily limited thereto.

The case 110 may include a body portion 111 accommodating the electrode assembly and an electrolyte in an internal accommodation space and a sealing portion 112 formed on at least one edge of the body portion 111 to seal the accommodation space of the case 110.

The body portion 111 includes a space accommodating the electrode assembly and may refer to a portion of the case 110 not sealed. In other words, the body portion 111 may refer to a portion of the case 110 not the sealing portion 112.

The sealing portion 112 is a portion sealing the accommodation space of the case 110 and may refer to at least one edge of the case 110. The sealing portion 112 may be formed by sealing outer casings forming the case 110 by heat fusion or the like while they face each other. The sealing portion 112 may include a tab sealing portion 113 in which a lead tab 120 is disposed and a body sealing portion 114 in which the lead tab 120 is not disposed.

Meanwhile, according to an embodiment of the present disclosure, the sealing portion 112 may be arranged on three edges among four edges of the battery cell 100. That is, the case 110 may be formed by folding a single sheet of outer casing to wrap the electrode assembly, and the outer casings may be sealed while facing each other at three edges that are not folded. In this manner, the case 110 may be formed with a structure having three sealing portions 112 by sealing three edges among four edges.

Here, a protrusion 130 may be formed on the folded edge (the edge disposed in a −Z-axis direction in the drawing) in which the sealing portion 112 is not formed as the outer casing of the case 110 protrudes laterally (in the −Z-axis direction) by a predetermined length a1 as compared to the body portion 111 toward that direction. The protrusion 130 may be referred to as a shark fin or delta fin.

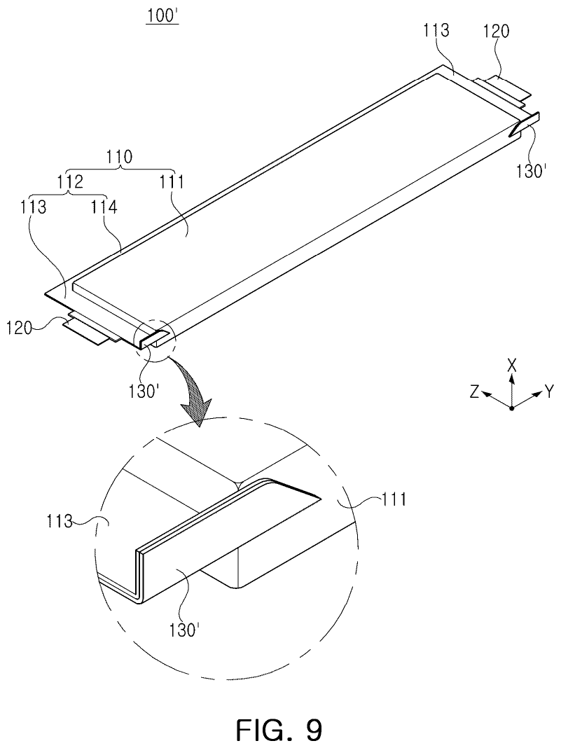

The battery cell 100 in which such a protrusion 130 is formed may occupy more unnecessary space by the predetermined length a1 than a battery cell (100′, see FIG. 9) in which the protrusion 130 described below is folded. In other words, the protrusion 130 described above is an unnecessary portion of the battery cell 100 in terms of energy, and it is important to remove or minimize the protrusion 130 in order to increase the energy density.

Meanwhile, for convenience, in the present disclosure, ‘lateral’ refers to a direction in which the protrusion 130 protrudes (the −Z-axis direction), and ‘side surface’ may refer to a surface facing laterally in each component (surface facing in the −Z-axis direction). For example, a side surface 100a of the battery cell 100 and a side surface 111a of the body portion 111 may refer to surfaces facing each other laterally (the −Z-axis direction) in which the protrusion 130 protrudes.

Hereinafter, a battery cell manufacturing apparatus for folding a protrusion 130 according to an embodiment of the present disclosure will be described.

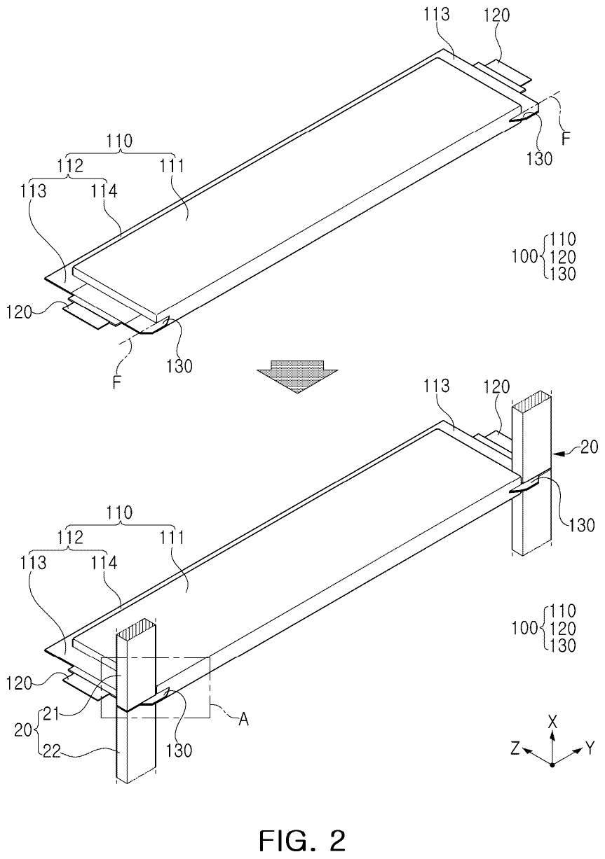

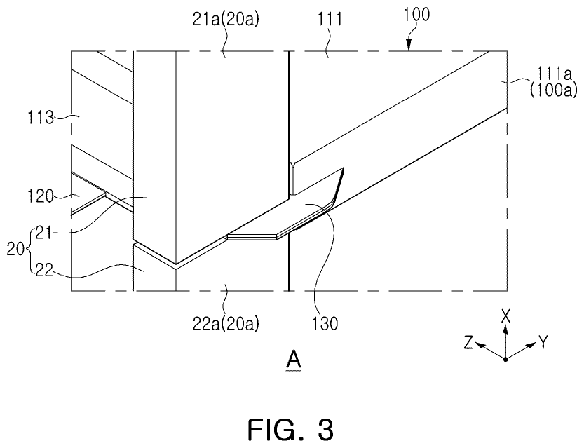

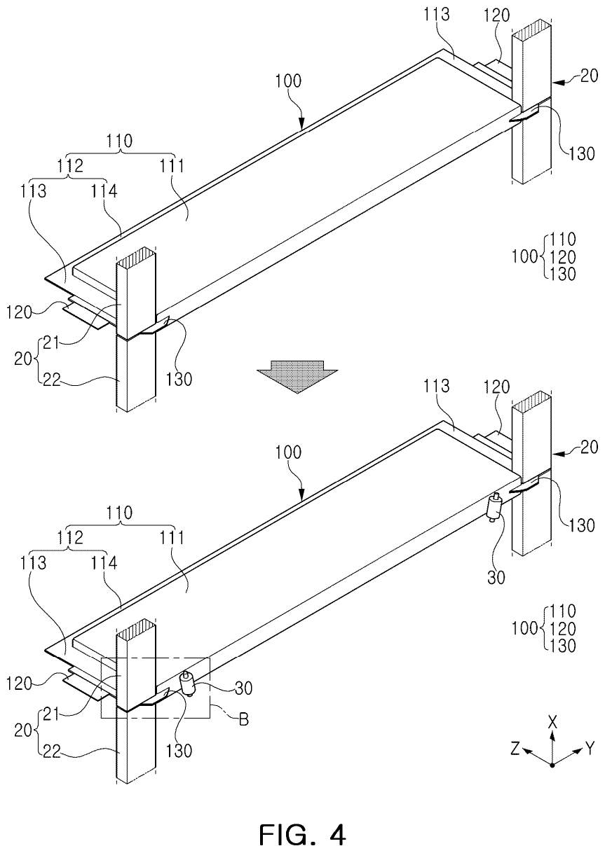

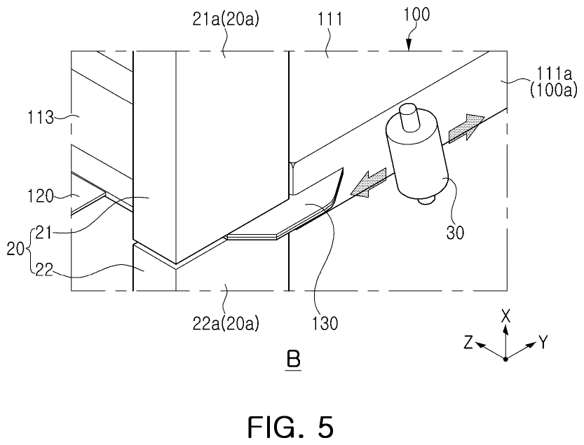

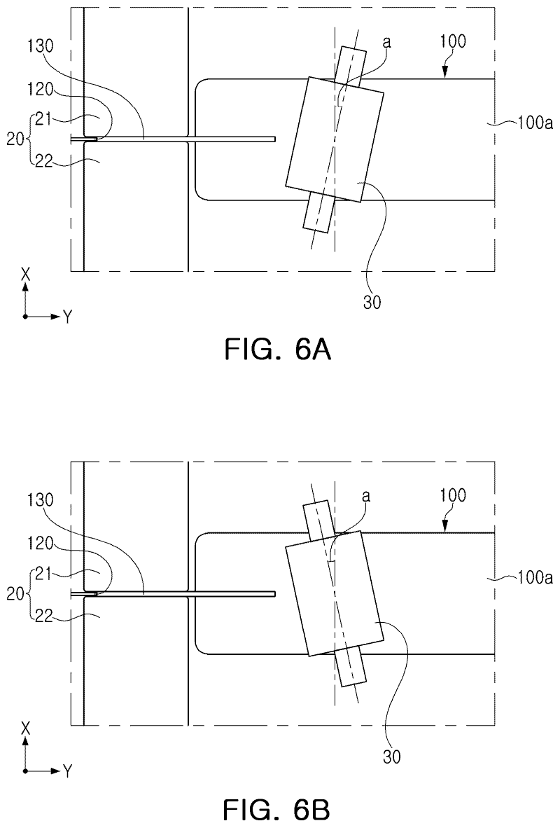

FIG. 2 is a diagram illustrating a process of manufacturing a battery cell through a pressing jig according to an embodiment of the present disclosure, FIG. 3 is an enlarged view of portion A of FIG. 2, FIG. 4 is a diagram illustrating an additional process of manufacturing a battery cell through a folding roller according to an embodiment of the present disclosure, FIG. 5 is an enlarged view of portion B of FIG. 4, and FIGS. 6A and 6B are diagrams illustrating angles of a folding roller from the side of a battery cell.

Referring to FIGS. 2 to 6B together, the battery cell manufacturing apparatus of the present disclosure is a manufacturing apparatus for the battery cell 100 having the case 110 accommodating an electrode assembly (not illustrated) and having the sealing portion 112 formed on at least one edge thereof and the protrusion 130 protruding laterally from the case 110 and may include a pressing jig 20 pressing the sealing portion 112 based on a virtual folding boundary line F that is a reference for folding the protrusion 130, thereby exposing the protrusion 130 laterally based on the folding boundary line F and a folding roller 30 folding the protrusion 130 exposed by the pressing jig 20 in a second direction (the X-axis direction), perpendicular to a first direction (a Y-axis direction), while moving in the first direction (the Y-axis direction) along the side surface 20a of the pressing jig 20 and the side surface 110a of the case 110.

More specifically, the battery cell manufacturing apparatus of the present disclosure may include the pressing jig 20 pressing the battery cell 100 in an up-and-down direction (an X-axis direction) along the folding boundary line F and the folding roller 30 folding the protrusion 130, while moving along the side surface 100a on which the protrusion 130 of the battery cell 100 is formed.

Referring to FIG. 2, the pressing jig 20 may include a first pressing jig 21 pressing an upper surface (a surface in a +X-axis direction) of the battery cell 100 and a second pressing jig 22 pressing a lower surface (a surface in a −X-axis direction). The first pressing jig 21 and the second pressing jig 22 may face each other with the case interposed in between in the second direction.

According to an embodiment, the protrusion 130 may be formed on both sides in a length direction (the Y-axis direction of FIG. 1), and the pressing jig 20 may press the battery cell 100 in the up-down direction (the X-axis direction of FIG. 2) near a region in which the protrusions 130 are formed.

Specifically, in the pressing jig 20, the first pressing jig 21 and the second pressing jig 22 may perform pressing in the tab sealing portion 113, while facing each other. The pressing jig 20 may expose the protrusion 130 toward the lateral side based on the folding boundary line. That is, the side surface 20a of the pressing jig 20 may be disposed parallel to the folding boundary line F in a height direction (the Z-axis direction of FIG. 1).

Meanwhile, the meaning of “parallel” in the present disclosure may include not only that the folding boundary line F extends parallel to the length direction (the Y-axis direction) from the side surface 100a of the battery cell 100, but also that the folding boundary line F is spaced apart from the side surface 100a of the battery cell 100 by a predetermined distance. In other words, a gap between the folding boundary line F and the side surface 100a of the battery cell 100 in the height direction (the Z-axis direction) may be 0 mm or more.

That is, the meaning of “parallel” in the present disclosure may include that the folding boundary line F is parallel to the side surface 20a of the pressing jig 20 or the side surface 100a of the battery cell 100 in the height direction (the Z-axis direction).

Through this, in the present disclosure, a folding target (e.g., the protrusion 130) may be folded in a state of being spaced apart from the side surface 100a of the battery cell 100 by a predetermined distance or may be folded based on the side surface 100a of the battery cell 100. That is, in the present disclosure, the folding of the folding target may be appropriately adjusted according to the length to be folded. The folding roller 30 may bend the protrusion based on the folding boundary line F 130, while moving in the length direction (the Y-axis direction) along the side surface 100a of the battery cell 100, specifically, the side surface 111a of the body portion 111 and the side surface 20a of the pressing jig 20, and press the protrusion 130 against the side surface of the pressing jig 20 to fold the protrusion 130. For example, the folding roller 30 may fold the protrusion 130 by pressing it against either the side surface of the first pressing jig 21 or the side surface of the second pressing jig 22. This will be described below with reference to FIGS. 4 and 5.

Referring back to FIG. 2, the folding boundary line F may be a virtual line disposed parallel to the side surface (100a, see FIG. 3) of the case of the battery cell 100. The pressing jig 20 may fix the protrusion 130, while exposing the protrusion 130 laterally, with the side surface 20a disposed parallel to the folding boundary line F.

For example, the side surface 20a of the pressing jig 20 may be disposed parallel to the side surface 100a of the case in the first direction. In other words, the pressing jig 20 may press the tab sealing portion 113 so that the side surface 20a is disposed parallel to the side surface 100a of the battery cell 100 in the length direction (the Y-axis direction). The pressing jig 20 may fix the battery cell 100 so that the battery cell 100 may not be shaken or move when the folding roller 30 described below moves, while pressing the upper and lower surfaces of the tab sealing portion 113.

In the drawing, the pressing jig 20 is illustrated as a thin rod shape, but the present disclosure is not limited thereto, and the specific shape is not particularly limited as long as it is a structure that may support the battery cell 100 so that the protrusion 130 is folded based on the folding boundary line F.

Referring to FIG. 3, the pressing jig 20 exposes the protrusion 130 laterally (the −Z axis direction).

Here, the expression “the pressing jig 20 exposes the protrusion 130” may mean that the pressing jig 20 does not directly press the protrusion 130 but presses the tab sealing portion 113 of the portion in which the protrusion 130 is formed and the side surface 20a of the pressing jig 20 is disposed parallel to the folding boundary line F or the side surface 100a of the battery cell 100.

That is, when the folding roller 30 described below moves along the side surface 20a of the pressing jig 20, the tab sealing portion 113 is not folded together with the protrusion 130, but only the protrusion 130 is folded.

Referring to FIGS. 4 and 5, in a state in which the battery cell 100 is fixed and the protrusion 130 is exposed through the pressing jig 20, the folding roller 30 may move in the length direction (the Y-axis direction). However, the movement direction of the folding roller 30 described above is only an example, and the folding roller 30 may move in a thickness direction (the X-axis direction in FIG. 2) and the height direction (the Z-axis direction). That is, the present disclosure is not limited to the driving direction of the folding roller 30.

The folding roller 30 may rotate based on a roller axis (not illustrated). The folding roller 30, while rotating around the roller axis and moving along the side surface 111a of the body portion 111 and the side surface 20a of the pressing jig 20, may push the exposed portion (the protrusion 130) of the pressing jig 20 toward the side surface 20a of the pressing jig 20 or the side surface 111a of the body portion 111 to fold the protrusion 130. That is, the folding boundary line F may refer to a boundary line between the tab sealing portion 113 and the protrusion 130. Accordingly, the protrusion 130 may be pressed between the side surface of the pressing jig 20 and the folding roller 30 in a state in which it is folded in the second direction based on the folding boundary line.

The folding roller 30 may move in the length direction (the Y-axis direction) along the side surface 100a of the battery cell 100, specifically, the side surface 111a of the body portion 111. In other words, the folding roller 30 may move along the side surface 111a of the body portion 111 and the side surface 20a of the pressing jig 20. In addition, the folding roller 30 may move in the length direction while being pressed so as to be in close contact with the side surface 111a of the body portion 111 and the side surface 20a of the pressing jig 20.

Referring to FIGS. 6A and 6B, the folding roller 30 may be provided to move in the length direction (the Y-axis direction) while being inclined at a predetermined angle (a) based on an axis parallel to the second direction (X-axis direction), parallel to the pressing jig 20.

The folding roller may be provided to be inclined at an angle within the range of −45 degrees to +45 degrees based on an axis, parallel to the X-axis direction.

For example, as illustrated in FIG. 6A, when the folding roller 30 moves to the left in the drawing, the protrusion 130 may be folded upwardly (the +X axis direction), and referring to FIG. 6B, when the folding roller 30 moves to the left in the drawing, the protrusion 130 may be folded downwardly (the −X axis direction). In this manner, the angle (a) of the folding roller 30 may be appropriately adjusted depending on the folding direction of the protrusion 130.

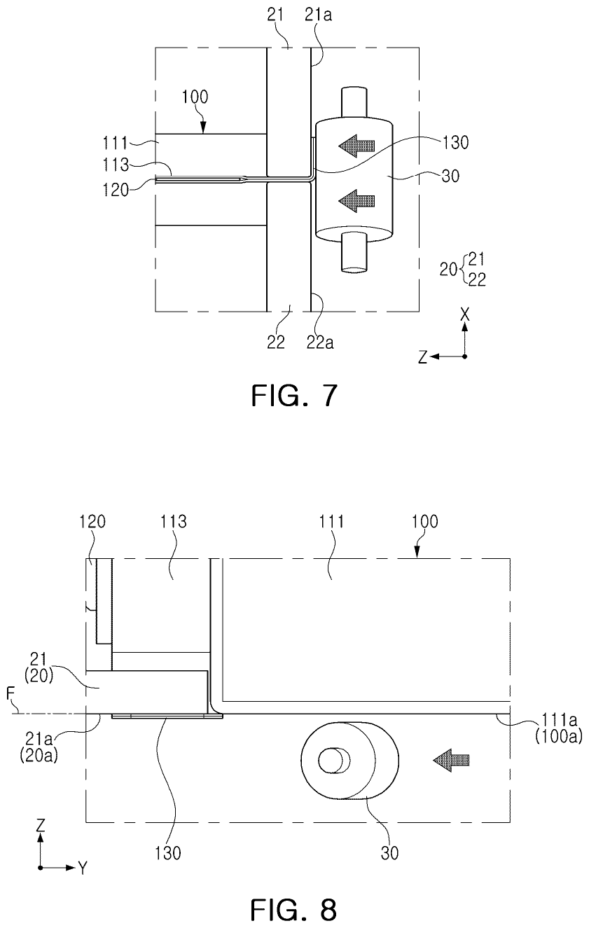

FIG. 7 is a diagram illustrating that the protrusion 130 is folded by the folding roller 30 from the front of the battery cell, and FIG. 8 is a diagram illustrating that the protrusion is folded by the folding roller from top of the battery cell.

Referring to FIGS. 7 and 8 together, the protrusion 130 may be folded on the side surface 111a of the body portion 111 by the pressing jig 20 and the folding roller 30.

In other words, the folding roller 30 may fold the protrusion 130 based on the folding boundary line F, while pushing the protrusion 130 against at least one of the side surface 20a of the pressing jig 20 or the side surfaces 111a of the body portion 111.

In addition, the folding roller 30 may fold the protrusion 130 in the direction of either the side surface 21a of the first pressing jig 21 or the side surface 22a of the second pressing jig 22.

FIGS. 7 and 8 illustrate that the folding roller 30 folds the protrusion 130 by pushing the protrusion 130 against the side surface 21a of the first pressing jig 21 among the side surface 21a of the first pressing jig 21 and the side surface 22a of the second pressing jig 22.

Specifically, the folding roller 30 may be provided to fold the protrusion 130 toward the first pressing jig 21 and push the protrusion 130 toward the side surface 21a of the first pressing jig 21. At this time, the protrusion 130 may be maintained in the folded state as pressure concentrates near the folding boundary line F by the pressing jig 20 and the folding roller 30.

In addition, as illustrated in FIG. 8, when the protrusion 130 is folded based on the folding boundary line F, the battery cell 100 may be left with only the minimum thickness of the protrusion 130 on the side and have no unnecessary component.

Meanwhile, in this specification, “the protrusion 130 is folded” may mean that the protrusion 130 is folded by the pressing jig 20 and the folding roller 30 and a length a1 protruding in one direction (the −Z axis direction) is reduced.

In this manner, in a state in which the folding boundary line F is determined by the pressing jig 20, the protrusion 130 may be folded and pressed through the folding roller 30, thereby minimizing elastic recovery of the protrusion 130 and reducing the protrusion length of the protrusion 130.

That is, as illustrated in FIG. 8, when the protrusion 130 is folded based on the folding boundary line F by the pressing jig 20 and the folding roller 30, the length protruding laterally (a −Z axis direction) may be reduced. Compared to FIG. 1, a length a1 protruding by the protrusion 130 may be reduced by the thickness of the protrusion 130 itself.

FIG. 9 is a view of a battery cell in which the protrusion is folded according to an embodiment of the present disclosure.

In order to distinguish a battery cell 100′ manufactured by the manufacturing apparatus of the present disclosure from the battery cell 100 in which the protrusion 130 is not folded, different reference numerals are used.

The battery cell 100′ with the protrusion 130 folded is advantageous in terms of energy density when accommodated in a battery module or battery pack, etc. because the area occupied by the protrusion 130 is reduced as much, as illustrated in the drawing. In other words, in the case of the battery cell 100 of FIG. 2, unnecessary space may be wasted due to the protrusion 130, whereas in the case of the battery cell 100′ of FIG. 9, unnecessary space may be minimized by folding the protrusion 130.

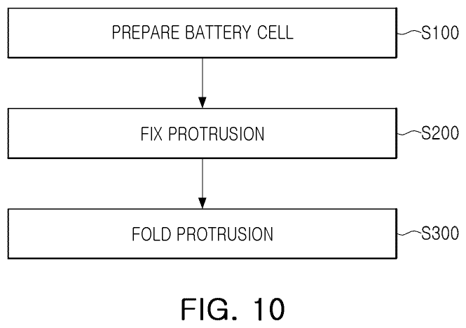

FIG. 10 is a flowchart of a method of manufacturing a battery cell according to an embodiment of the present disclosure.

The battery cell manufacturing apparatus and the operation method of the present disclosure have been described above, so redundant descriptions thereof will be omitted.

Referring to FIG. 10, the method of manufacturing a battery cell according to an embodiment of the present disclosure is a method of manufacturing the battery cell 100 including the case 110 accommodating an electrode assembly and having the sealing portion 112 formed on at least one edge of the case 110 and the protrusion 130 protruding laterally from the case 110 and may include a first operation (S100) of preparing the battery cell 100 having the protrusion 130 protruding laterally from the case 110; a second operation (S200) of pressing the case 110 with the pressing jig 20 to expose the protrusion 130 laterally; and a third operation (S300) of folding the protrusion 130 exposed by the pressing jig 20 in the second direction (the X-axis direction), perpendicular to the first direction (the Y-axis), while the folding roller 30 moves along the side surface 20a of the pressing jig 20 and the side surface 110a of the case 110 in the first direction (the Y-axis direction).

More specifically, the method of manufacturing a battery cell according to an embodiment of the present disclosure may include the first operation (S100) of preparing the battery cell 100 having the protrusion 130, the second operation (S200) of fixing the battery cell 100 through the pressing jig 20 so that the protrusion 130 is exposed, and the third operation (S300) of folding the protrusion 130 while moving along the side surface 20a of the pressing jig 20 through the folding roller 30.

The battery cell in the first operation (S100) may be the battery cell 100 provided with the protrusion 130 in FIG. 1, and descriptions thereof are given above and thus omitted here.

The second operation may include an operation of setting a virtual line, parallel to the side surface 100a of the battery cell 100, as the folding boundary line F through a separate controller (not illustrated) and an operation of pressing the sealing portion 112 (specifically, the tab sealing portion 113) by the pressing jig 20 along the folding boundary line F.

The operation of pressing the sealing portion 112 by the pressing jig 20 may include an operation of pressing the tab sealing portion 113, while the side surface 20a of the pressing jig 20 is disposed parallel to the folding boundary line F in the Z-axis direction (see FIG. 2).

In the third operation (S300), the protrusion 130 may be folded, while the folding roller 30 pressed against the side surface 111a of the body portion 111 moves to the side surface 20a of the pressing jig 20 in the length direction (the Y-axis direction) (see FIG. 4).

The present disclosure may provide the battery cell manufacturing apparatus and manufacturing method capable of removing or minimizing an unnecessary protrusion formed in a battery cell case.

The present disclosure may provide the battery cell manufacturing apparatus and manufacturing method capable of minimizing a portion protruding from the edge of a pouch by sealing a pouch-shaped outer casing to seal the case.

Although the embodiments of the present disclosure have been described above, the scope of the present disclosure is not limited thereto and it will be apparent to those skilled in the art that various modifications and variations may be made within the scope not departing from the technical idea of the present disclosure described in the claims. For example, the present disclosure may be implemented by deleting some of the components in the above-described embodiments, and the respective embodiments may be implemented in combination with each other.

The above-described contents are merely examples adopting the principles of the present disclosure, and other components may be further included without departing from the scope of the present disclosure.

What is claimed is:

1. An apparatus of manufacturing a battery cell including a case accommodating an electrode assembly and having a sealing portion formed on at least one edge thereof and a protrusion protruding laterally from the case, the apparatus comprising:
a pressing jig pressing the sealing portion based on a virtual folding boundary line that is a reference for folding the protrusion, to expose the protrusion laterally based on the folding boundary line; and
a folding roller folding the protrusion exposed by the pressing jig in a second direction, perpendicular to a first direction, while moving in the first direction along a side surface of the pressing jig and a side surface of the case.

2. The apparatus of claim 1, wherein the folding boundary line is a virtual line, parallel to the side surface of the case.

3. The apparatus of claim 1, wherein the folding roller bends the protrusion based on the folding boundary line and presses the protrusion against the side surface of the pressing jig.

4. The apparatus of claim 3, wherein the pressing jig includes a first pressing jig and a second pressing jig facing each other with the case interposed in between in the second direction, and the folding roller presses the protrusion against either a side surface of the first pressing jig or a side surface of the second pressing jig.

5. The apparatus of claim 1, wherein the side surface of the pressing jig is disposed parallel to the side surface of the case in the first direction.

6. The apparatus of claim 1, wherein the protrusion is pressed between the side surface of the pressing jig and the folding roller in a state in which it is folded in the second direction based on the folding boundary line.

7. The apparatus of claim 2, wherein the folding roller is provided to be inclined at a predetermined angle based on an axis, parallel to the second direction.

8. A method of manufacturing a battery cell including a case accommodating an electrode assembly and having a sealing portion formed on at least one edge thereof and a protrusion protruding laterally from the case, the method comprising:
a first operation of preparing a battery cell with the protrusion protruding laterally from the case;
a second operation of pressing the case with a pressing jig to expose the protrusion laterally; and
a third operation of folding the protrusion exposed by the pressing jig in a second direction, perpendicular to a first direction, while the folding roller moves along the side surface of the pressing jig and the side surface of the case in the first direction.

9. The method of claim 8, wherein the second operation includes an operation of setting a virtual line, parallel to the side surface of the battery cell, as a folding boundary line, and pressing the sealing portion by the pressing jig along the folding boundary line.
